(19) United States
(12) Patent Application Publication
(10) Pub. No.: US 2025/0349155 A1
(43) Pub. Date: Nov. 13, 2025

(54) FACE RECOGNITION USING AN AUTOMATICALLY ADJUSTING DECISION THRESHOLD

(71) Applicant: Lenovo Enterprise Solutions (Singapore) Pte Ltd., Singapore (SG)

(72) Inventors: Zhenyu Yang, Morrisville, NC (US); Shanshan Wei, Beijing (CN)

(21) Appl. No.: 19/049,804

(22) Filed: Feb. 10, 2025

Related U.S. Application Data
(63) Continuation of application No. PCT/CN2024/092525, filed on May 11, 2024.

(51) Int. Cl. G06V 40/50; G06V 40/16

(52) U.S. Cl. CPC G06V 40/50; G06V 40/173

(57) ABSTRACT

A computer program product and a method perform various operations including: capturing face images of people at a particular location during a current period; performing, for each of the face images captured during the current period, face recognition using a value of a decision threshold to make a determination whether the captured face image and a stored face image in a database of stored face images are of the same person; calculating a current positive determination rate for the face images captured during the current period; and automatically adjusting the value of the decision threshold for performing the face recognition during a subsequent period following the current period. The value of the decision threshold is increased (decreased) for performing the face recognition during the subsequent period in response to the current positive determination rate being greater than (less than) a target positive determination rate during the current period.

### BACKGROUND

The present disclosure relates to face recognition applications and systems that utilize face recognition.

### BACKGROUND OF THE RELATED ART

Face recognition or facial recognition refers to technology that can automatically recognize a human face from a digital image. While face detection can identify the presence of a human face in a digital image, face recognition goes further to include some face comparison or face matching between the human face found in one image and the human face found in another image. Typically, the face comparison is performed after processing the image into a smaller data set that represents the differentiating features of a face. This smaller data set is known as a “faceprint.”

Face identification is one type of face recognition. In face identification, a faceprint from a new face image is obtained and compared against a database of known faceprints, where each known faceprint is associated with a specific known individual. If the faceprint from the new face image is sufficiently similar to any of the known faceprints, then a facial recognition system returns a potential match. For example, the new face image may be obtained by a security camera outside a secure area and the database of known faceprints may include a faceprint for every person that is authorized to access the secure area. If the security camera captures a face image of a person with a faceprint that is sufficiently similar to a faceprint in the authorized person database, then a security system connected to the security camera may enable the person to access the secure area.

Face verification is another type of facial recognition. In face verification, a faceprint from a newly captured face image is obtained and compared to a stored faceprint. The face comparison or face matching is performed without necessarily knowing or determining the identity of the person associated with the face. For example, a smartphone owner may setup their smartphone with one or more face images of authorized users, where the smartphone may store at least the faceprints of the authorized users. Subsequently, the smartphone will unlock in response to a camera on the smartphone capturing a face image having a faceprint that is sufficiently similar to (“matches”) a stored faceprint of one of the authorized users.

Face clustering is yet another type of facial recognition that processes faceprints from a set of images in order to cluster or group the images that show the same person. For example, face clustering may be used by a smartphone to form separate clusters of images for each person that appears in more than a predetermined number of images stored in a photos folder.

Face tracking is a further type of facial recognition. In face tracking, faceprints are processed from multiple face images and compared for the purpose of tracking a person's movement. Face tracking does not attempt to determine the identity of the person, but rather to merely determine the movement of the person.

A facial recognition system may utilize a digital camera to capture a face image and provide the face image to a facial recognition software application. However, depending upon the task to be performed, the facial recognition application may attempt co-registration of any two face images that are being compared. The term “co-registration” refers to a process of geometric alignment of two face images that were captured from different angles and are, therefore, in different co-ordinate spaces. The co-registration process transforms one of those images onto the other image so that they are in the same co-ordinate space. However, even two images of the same person may have some degree of variation. So, face recognition applications use a decision threshold that defines the maximum degree of variation between two images that will still support a decision that the two images are of the same person.

### BRIEF SUMMARY

Some embodiments provide a computer program product comprising a non-volatile computer readable medium and non-transitory program instructions embodied therein, the program instructions being configured to be executable by a processor to cause the processor to perform various operations. The operations comprise capturing face images of people at a particular location during a current period and performing, for each of the face images captured during the current period, face recognition using a value of a decision threshold to make a determination whether the captured face image and a stored face image in a database of stored face images are of the same person. A positive determination indicates that the captured face image and the stored face image are of the same person. The operations further comprise calculating a current positive determination rate for the face images captured during the current period and automatically adjusting the value of the decision threshold for performing the face recognition during a subsequent period following the current period. The value of the decision threshold is increased for performing the face recognition during the subsequent period in response to the current positive determination rate being greater than a target positive determination rate during the current period. Furthermore, the value of the decision threshold is decreased for performing the face recognition during the subsequent period in response to the current positive determination rate being less than the target positive determination rate during the current period.

Some embodiments provide a method comprising various operations. The operations comprise capturing face images of people at a particular location during a current period and performing, for each of the face images captured during the current period, face recognition using a value of a decision threshold to make a determination whether the captured face image and a stored face image in a database of stored face images are of the same person. A positive determination indicates that the captured face image and the stored face image are of the same person. The operations further comprise calculating a current positive determination rate for the face images captured during the current period and automatically adjusting the value of the decision threshold for performing the face recognition during a subsequent period following the current period. The value of the decision threshold is increased for performing the face recognition during the subsequent period in response to the current positive determination rate being greater than a target positive determination rate during the current period. Furthermore, the value of the decision threshold is decreased for performing the face recognition during the subsequent period in response to the current positive determination rate being less than the target positive determination rate during the current period.

### BRIEF DESCRIPTION OF THE SEVERAL VIEWS OF THE DRAWINGS

FIG. 1 is a diagram of a system in which one or more embodiments may be performed.

FIG. 2 is a diagram of a computer that may be used to perform a computer program product according to one or more embodiments.

FIG. 3 is a flowchart of operations according to some embodiments.

FIG. 4 is a flowchart of operations according to some embodiments.

### DETAILED DESCRIPTION

Some embodiments provide a computer program product comprising a non-volatile computer readable medium and non-transitory program instructions embodied therein, the program instructions being configured to be executable by a processor to cause the processor to perform various operations. The operations comprise capturing face images of people at a particular location during a current period and performing, for each of the face images captured during the current period, face recognition using a value of a decision threshold to make a determination whether the captured face image and a stored face image in a database of stored face images are of the same person. A positive determination indicates that the captured face image and the stored face image are of the same person. The operations further comprise calculating a current positive determination rate for the face images captured during the current period and automatically adjusting the value of the decision threshold for performing the face recognition during a subsequent period following the current period. The value of the decision threshold is increased for performing the face recognition during the subsequent period in response to the current positive determination rate being greater than a target positive determination rate during the current period. Furthermore, the value of the decision threshold is decreased for performing the face recognition during the subsequent period in response to the current positive determination rate being less than the target positive determination rate during the current period.

In some embodiments, the face images of people at a particular location may be captured with a digital camera connected to a computer for storing the face images. The computer connected to the digital camera may further process the face images or forward the face images to another computer for processing according to some embodiments. In some instances, the digital camera or multiple digital cameras may be mounted or otherwise secured within the particular location in a manner that facilitates capturing face images of the people that pass through the particular location. Non-limiting examples of the particular locations include public spaces such as airport terminals and subway or train stations, as well as private spaces such as office building lobbies or the security gates to a manufacturing facility. In one option, the computer may perform an initial operation of face detection prior to capturing the face image. In another option, the computer may perform some amount of pre-processing to sharpen the face image or crop a captured image to include only the face image and a small margin around the face image.

The accuracy of the face recognition determinations depends on various factors, such as the quality of the camera(s) used, the positioning of the camera(s), environmental conditions such as lighting of the location where the camera(s) is/are deployed, and the manner in which the face recognition is implemented. As one example, a security checkpoint in an office building lobby may require each person to pause, remove any items covering a portion of their face, and look directly into a camera that is mounted at the optimal height with optimal light conditions to capture a high quality face image of the person as a condition of being allowed access into the office building. However, in another example, a camera may be mounted to the ceiling or wall of a walkway at a height well above people's heads in order to have a view of each person in a crowd of people passing through the walkway. In the latter scenario, the lighting conditions may vary throughout the day affecting the brightness and contrast in a captured face image, each person is unlikely to have their head directed exactly toward the camera such that some facial features may be out of the camera's field of view, and there is no requirement that each person remove items like sunglasses, hats or scarves that may be covering or occluding a portion of their face. Unfortunately, these conditions may prevent the capture of a high quality face image that would enable the face recognition system to make a determination with a high level of confidence. Embodiments described herein automatically adjust the value of a decision threshold utilized by the face recognition system in a manner that attempts to approach and/or maintain a target rate of positive determinations (i.e., a “target positive determination rate”) regardless of the environmental conditions under which the face images are captured.

Accordingly, automatic adjustment of the decision threshold may prevent a first scenario in which the decision threshold is so high/strict (and static) and the captured face images are so poor that the face recognition system makes too few or no positive determinations. In this first scenario, it is very likely that many “false negatives” are occurring. A “false negative” occurs when a person in the captured face image should be positively detected but was not. In other words, despite the actual conditions causing the face recognition system to make a negative determination, ideal conditions and/or a less strict decision threshold would have led to a positive determination that the captured face image is of a person for which there is a stored face image in the database.

Similarly, automatic adjustment of the decision threshold may also prevent a second scenario in which the decision threshold is so low/relaxed (and static) that the face recognition system makes too many positive determinations regardless of the poor quality of the captured face images. In this second scenario, it is very likely that many “false positives” are occurring. A “false positive” occurs when the captured face image is identified as being an image of a person for which there is an image in the database, but the captured face image is actually not of a person in the database. In other words, despite the face recognition system making a positive determination, ideal conditions and/or a stricter decision threshold would have led to a negative determination (i.e., the captured face image is of a person for which there is not a stored face image in the database).

The amount and frequency with which the decision threshold is adjusted depends directly upon the rate of positive determinations, which may indirectly depend upon the actual environmental conditions under which the face images are being captured. Pretrained AI models for face recognition are closely correlated with the data used during their training, which may not accurately reflect the actual on-site conditions (i.e., lighting, facial expressions, occlusions, etc.). However, as there are changes in the actual conditions at the on-site location where the face images are being captured, embodiments described herein will automatically adjust the decision threshold used by the face recognition application to manage or control the rate of positive determinations.

Embodiments automatically adjust the decision threshold value in a direction that tends to move the positive determination rate closer to the target positive determination rate. For example, if the current positive determination rate is greater than the target positive determination rate, then increasing the decision threshold (i.e., requiring greater similarity between two images to make a positive determination/match) will tend to reduce the amount of actual positive determinations during a subsequent period. Conversely, if the current positive determination rate is less than the target positive determination rate, then decreasing the decision threshold (i.e., requiring less similarity between two images to make a positive determination/match) will tend to increase the amount of actual positive determinations during the subsequent period. It should be recognized that the decision threshold is automatically adjusted in a particular direction (i.e., increased or decreased) to have an influence on the positive determination rate in the subsequent period. However, other factors, such as a further change in the environmental conditions or a variation in the population of people that enter the particular location and have their images captured, may also affect the positive determination rate during that subsequent period. Accordingly, if the adjusted decision threshold that is used during one period does not lead to the face recognition achieving the target positive determination rate, then the decision threshold is further adjusted during the next period. There is no limit on the number of times that the decision threshold may be adjusted in one direction or another. For example, the decision threshold may be increased multiple times in response a high positive determination rate occurring due in part to one set of environmental conditions and then may be decreased multiple times in response to a low positive determination rate occurring due in part to a second set of environmental conditions.

Some embodiments may include repeating the operations during each of a plurality of sequential periods. For example, embodiments may repeat the operations of capturing face images, performing face recognition using a value of a decision threshold, calculating a current positive determination rate and automatically adjusting the value of the decision threshold for performing the face recognition during a subsequent period following the current period. The operations are preferably repeated during each period during use of the computer program product, even if the current positive determination rate has reached the target positive determination rate, since the conditions may change and repeating the operations allows adjustment of the decision threshold to reflect those changed conditions.

In some embodiments, a positive determination indicates that the captured face image is of the same person as in any of the stored face images in the database. For example, a newly captured face image may be compared to each of a large number of faced images stored in the database. Although the newly captured face image is compared to only one of the stored face images at a time, the face recognition system may compare the newly captured face image to each of the stored face images and then identify which of the stored face images is the closest (i.e., has the most similarity; smallest distance) to the newly captured face image. The face recognition system may then use the current decision threshold (confidence threshold) to determine whether the newly captured face image is of the same person as in the identified closest or most similar stored face image. Accordingly, a positive determination may be made in response to determining that any of the stored face images (i.e., stored in the database) are of the same person as the newly captured face image.

In some embodiments, the value of the decision threshold (also referred to as a confidence threshold) may, for example, be a value between 0 and 1. A decision threshold value close to 1 requires a high degree of similarly between the newly captured face image and one of the stored face images, whereas a decision threshold value close to 0 requires only a small degree of similarly between the newly captured face image and one of the stored face images. For example, the face recognition application may perform various co-registration steps to align the two face images being compared, which may involve co-registration of the face prints (sets of facial landmarks) and then calculate a difference or distance between the two face images. In one option, the distance between the two face images may be a sum of the root mean square distances between corresponding facial landmarks in the two face images. This distance may optionally be converted to a confidence score that indicates how likely it is that the two face images are of the same person. If the confidence score is scaled to a value from 0 to 1 similar to the decision threshold (confidence threshold), then a positive determination may be made if the confidence score is greater than the decision threshold.

In some embodiments, the operation of performing, for each of the face images captured during the current period, face recognition includes calculating, for each of the face images captured during the current period, an amount of difference between a face print for the captured face image with a face print for each of a plurality of stored face images. The operation may further include making a positive determination for the captured face image in response to the calculated amount of difference being less than the value of the decision threshold or in response to a confidence score being greater than the value of the decision threshold.

In some embodiments, the operation of automatically adjusting the value of the decision threshold for performing face recognition during the subsequent period following the current period may include incrementally adjusting the value of the decision threshold by a predetermined amount. In other embodiments, the operation of automatically adjusting the value of the decision threshold for performing face recognition during the subsequent period following the current period may include incrementally adjusting the value of the decision threshold by a predetermined percentage of the value of the decision threshold for performing face recognition during the current period. Other adjustment amounts or other means for determining adjustment amounts may be implemented.

In some embodiments, increasing the value of the decision threshold requires greater similarity between the captured face image and the stored face image to make a positive determination. Conversely, decreasing the value of the decision threshold requires less similarity between the captured face image and the stored face image to determine a positive match.

In some embodiments, each of the periods may be defined by an amount of time or a number of determinations whether the captured face image is of the same person as one of the stored face images in the database of stored face images. As used herein, the “number of determinations” is the number of newly captured face images that are compared to the database of stored face images to determine whether there is a stored image of the same person as in the newly captured face image. Only some fraction of the “number of determinations” will be positive determinations.

In some embodiments, the current period may end and the subsequent period may begin in response to a difference between the current positive determination rate and the target positive determination rate exceeding a maximum threshold. For this embodiment, the current positive determination rate may be updated after each determination, whether positive or negative, so that the current positive determination rate is known throughout the current period. Accordingly, the current period may be terminated, and the decision threshold may be adjusted if the current positive determination rate is more than the maximum threshold amount above or below the target positive determination rate. Optionally, the current period may have a minimum number of determinations and/or duration before the current period may be terminated in this manner.

In some embodiments, the operation of calculating the current positive determination rate for the face images captured during the current period includes identifying a total number of the determinations are made during the current period and identifying a number of the positive determinations made during the current period, wherein the current positive determination rate is the number of positive determinations divided by the total number of determinations. In one option, the current positive determination rate may be calculated only at the end of the current period. In another option, the current positive determination rate may be calculated at any point during the current period, such as after each determination or after each positive determination.

In some embodiments, the operation of capturing face images of people at the particular location during the current period includes receiving the face images from a camera positioned or mounted in the particular location. Optionally, the face images may be received from a plurality of cameras positioned or mounted in the particular location. The particular location may be a small defined location, such as an entryway to a building, or a large continuous or discontinuous area, such as an airport terminal.

In some embodiments, the operation of performing, for each of the face images captured during the current period, face recognition using a value of a decision threshold to make a determination whether the captured face image and a stored face image in a database of stored face images are of the same person may include submitting the captured face image, one or more of the stored face images in the database, and the value of the decision threshold to a face recognition system, and receiving the determination whether the captured face image and any of the one or more of the stored face images in a database are of the same person from the face recognition system. For example, the face recognition system may run on an individual computer, a set of servers in a datacenter or in the cloud. The images may be collected by any device with a camera and network connection, without requiring the collecting device to do any of the specific face analysis. Optionally, the face recognition system may be a remote system operated by a third party, such as DeepFace or FaceNet. Furthermore, some techniques for implementing artificial intelligence (AI) systems that perform face recognition include machine learning algorithms (e.g., Support Vector Machines, Neural Networks), clustering-based methods (e.g., K-means, DBSCAN), and statistical approaches (e.g., Histogram-based thresholding, Otsu's method).

In some embodiments, a system administrator may manually set the target positive determination rate. The value selected from the target positive determination rate may be a known value based on previous experience. For example, if it is known that about 0.5% of all visitors to an airport are on a security risk list, then the target positive determination rate for an embodiment implemented in an airport may be set to 0.5%. Alternatively, the value selected for the target positive determination rate may be designated according to a capacity to process positive determinations. For example, if security screeners have been staffed to hand screen 1% of all passengers passing through security, then the target positive determination rate for an embodiment implemented in a security screening area may be set to 1%.

In one detailed example, assume that a security camera is being used to monitor pedestrians and it is anticipated, based on experience or history, that about 0.1% of the detected pedestrians will pose a threat. Accordingly, the targeted positive determination rate may be set to 0.1% (positive determinations/total determinations). If the percentage of positive determinations (the positive determination rate) for a current period varies from the target positive determination rate (an expected determination rate), then the decision threshold may be adjusted so that the actual positive determination rate moves toward the expected positive determination rate. In this example, the adaptive thresholding algorithm would need to monitor the number of pedestrians (perhaps 1000) and the number of positive determinations or matches (perhaps 10), then calculate a percentage/rate of positive determinations (here 1%), compare the calculated/actual percentage to target determination percentage/rate (0.1%) and adjust (increase) the decision threshold to bring the positive determination rate down toward the target positive determination rate. The decision threshold may be adjusted iteratively over a plurality of periods (based on time or number of determinations), where the actual positive determination rate during one period or set of instances are monitored and used along with the target positive determination rate to determine whether, and in what direction, to adjust the decision threshold during the next period or set of instances.

In another example, an airport may staff their security team to perform a manual search of 1% of the travelers passing through the airport. If a face recognition application is comparing the travelers' face images to a database of face images that are on a watch list, the adaptive/dynamic decision threshold may be adjusted so that only 1% of the travelers that most closely match a face image in the database are selected for a manual search. The security camera will capture source facial images from the pedestrians arriving at a security check point and a facial recognition application will compare the source facial images against a database of target facial images for individuals that are known to be threats. If recent data has observed that 2% of the pedestrians are flagged as potential threats because their source facial images are determined to match one of the target facial images, then the facial recognition software/system is making too many positive detections. In this case, the decision threshold or confidence threshold for determining a match between a source facial image and a target facial image may be raised (i.e., made more difficult to find a match) so that fewer pedestrians are flagged as potential threats, and a larger number of people are allowed to pass through the security check without being incorrectly identified as threats.

Some embodiments provide a method comprising various operations. The operations comprise capturing face images of people at a particular location during a current period and performing, for each of the face images captured during the current period, face recognition using a value of a decision threshold to make a determination whether the captured face image and a stored face image in a database of stored face images are of the same person. A positive determination indicates that the captured face image and the stored face image are of the same person. The operations further comprise calculating a current positive determination rate for the face images captured during the current period and automatically adjusting the value of the decision threshold for performing the face recognition during a subsequent period following the current period. The value of the decision threshold is increased for performing the face recognition during the subsequent period in response to the current positive determination rate being greater than a target positive determination rate during the current period. Furthermore, the value of the decision threshold is decreased for performing the face recognition during the subsequent period in response to the current positive determination rate being less than the target positive determination rate during the current period.

The foregoing method embodiment may further include any one or more of the operations described herein in reference to a computer program product. Conversely, any of the computer program product embodiments may include further program instructions to implement or initiate any one or more aspects of the methods described herein.

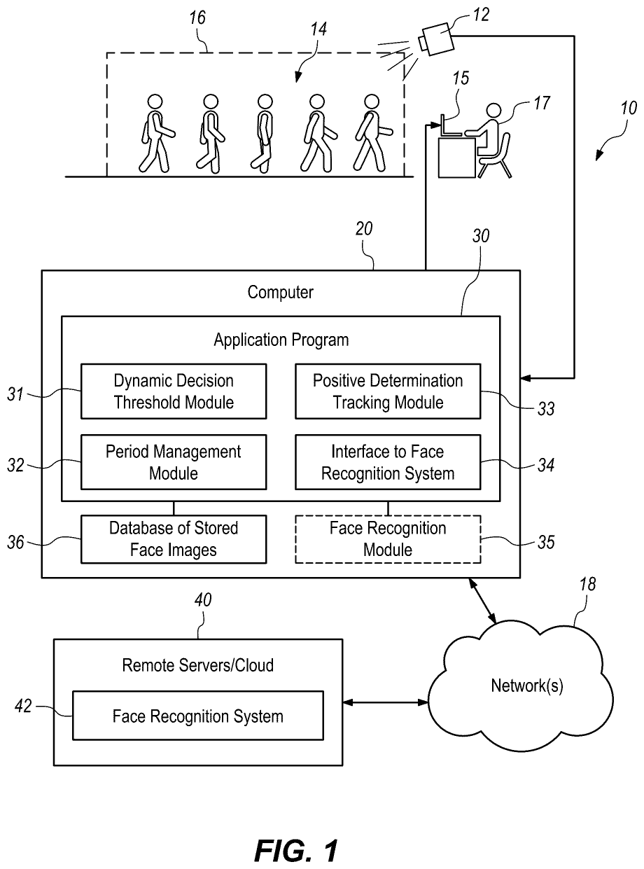

FIG. 1 is a diagram of a system 10 in which one or more embodiments may be performed. The system 10 includes a computer 20 that is connected for wired or wireless communication with a camera 12. The camera 12 may be mounted in a position to monitor people 14 moving through a particular location or space 16. The camera 12 will capture face images of each person that passes into or through the particular location 16 and provide each captured face image to the computer 20.

The computer 20 performs operations as a result of executing the program instructions of an application program 30. In the embodiments shown, the application program 30 includes four modules, although the logic of the application program may include more or fewer modules and may be organized in a different manner. A dynamic decision threshold module 31 may provide an initial decision threshold for use during an initial period and calculate adjustments to the decision threshold for use during each subsequent period. The dynamic decision threshold module may also receive and use the value of the target positive determination rate. Accordingly, the dynamic decision threshold module may identify whether the positive determination rate for the current period is greater than or less than the target positive determination rate and use that information to decide whether to increase or decrease the value of the decision threshold for use during the next period.

A period management module 32 may monitor one or more variables to determine when a current period ends, and a subsequent period begins. The period management module may be as simple as a timer or a counter of the number of captured face images that are received from the camera 12 and processed by the application program 30. However, the period management module may also make more complex calculations to end a period based on a variable condition, such as recognizing that the desired positive determination rate being achieved using the current decision threshold is significantly different than the target positive determination rate. For example, if the positive determination rate during the current period is 2% and the target positive determination rate is 1%, then the period management module may, in some embodiments, end the current period as a result of the difference between current and target positive determination rates exceeding a 0.5% threshold. Ending the period based upon this condition or some similar condition enables the dynamic decision threshold module 31 to adjust the decision threshold for use during the next period with the objective of moving the positive determination rate during that next period closer to the target positive determination rate.

A positive determination tracking module 33 monitors the number of determinations made by the application program 30 during the current period, which is typically one determination per face image received from the camera 12, as well as the number of positive determinations during the current period. Accordingly, the positive determination tracking module may calculate a positive determination rate for the current period, either at the end of the current period or throughout the current period. In some embodiments, a “determination” is one instance of concluding whether or not the captured face image matches any of the face images stored in a database. The result of such a determination is either a positive determination (i.e., a match for the captured face image was found in the database) or a negative determination (i.e., a match for the captured face image was not found in the database). Although the present embodiments are focused on adjusting the decision threshold from one period to the next, the positive or negative determination should also be output, perhaps on a display screen 15, to a user 17 for taking action in regard to the positive and/or negative determinations.

A face recognition system interface 34 supports communication to and from a face recognition logic, which may be a local face recognition module 35 that runs on the same computer 20 as the application program 30 or a face recognition system 42 that runs on a remote server or cloud 40. Accordingly, the face recognition system interface 34 may submit queries to the face recognition logic, either through software in the case of the local face recognition module 35 or over the network(s) 18 that connect the computer 20 to the remote servers or cloud 40. The queries submitted to the recognition logic may include a captured face image, a stored face image, and the current decision threshold. The face recognition logic will then compare the two face images, calculate the difference between the two face images, and determine whether the calculated difference meets or does not meet the current decision threshold (confidence threshold). The face recognition logic will then return either a positive determination or a negative determination to the face recognition system interface 34 for sharing with the positive determination tracking module 33.

The local face recognition module 35 and/or the remote face recognition system 42 may be pretrained artificial intelligence models for performing face recognition. For example, the remote face recognition system may be operated by a third party, such as DeepFace or FaceNet. Embodiments described herein do not require changes to the face recognition algorithms, but rather provide a dynamic decision threshold, where the current decision threshold is provided to the face recognition for use in making positive and negative determinations during a particular period. In one option, the value of the decision threshold that should be used during a current period may be sent once during the period and used by the face recognition system until a new value of the decision threshold is provided. In another option, the decision threshold that should be used for the comparison of any two face images may be sent along with the two face images. In a still further option, if the database of stored face images have already been sent to and stored by the face recognition module, then the minimum information that the face recognition system interface 34 needs to provide to the face recognition system 35, 42 is the newly captured face image and any change in the decision threshold.

A database of stored face images 36 is stored on a data storage device accessible to the computer 20. The face images stored in the database 36 may be associated with people having some common characteristic. In some non-limiting examples, each face image stored in the database may be a person that is being sought for questioning, sought for a prior legal violation, or believed to be security risk. In other non-limiting examples, the face images stored in the database may be of people that are authorized to enter the particular location 16 and a negative determination may indicate that the newly captured face image is of a person that is not authorized. Accordingly, embodiments could implement a dynamic (automatically adjusted) decision threshold for approaching or achieving a target negative determination rate. In one option, a copy of the database 36 may be provided to the remote face recognition system 42 so that the face images stored in the database 36 do not have to be transmitted to the remoter servers or cloud 40 for each determination.

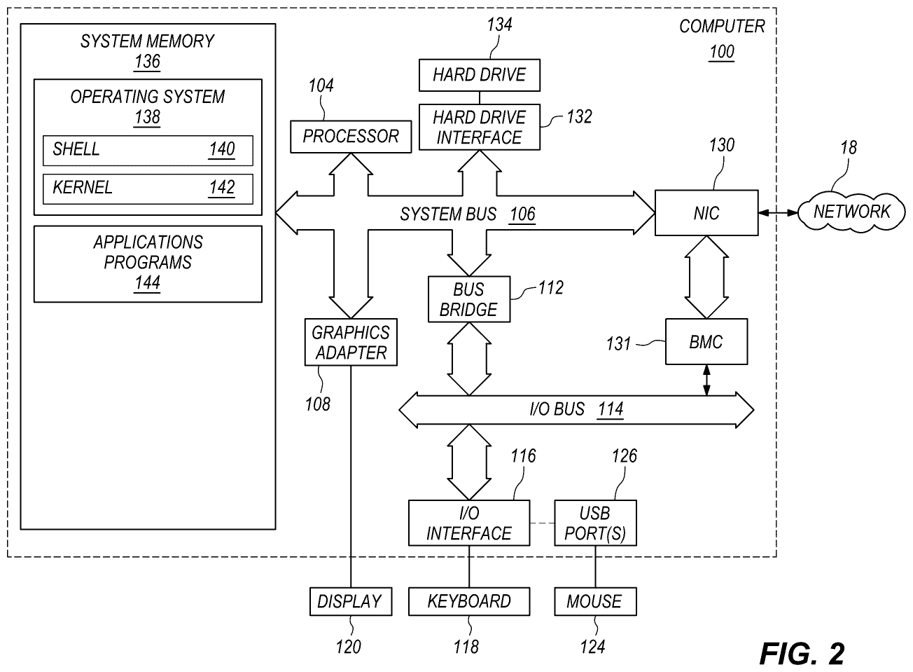

FIG. 2 is a diagram of one embodiment of a computer 100 that may be used to perform a computer program product according to one or more embodiments and may be representative, but not limiting, of the configuration of the computer 20 and/or the remote servers or cloud 40 of FIG. 1. The computer 100 includes a processor unit 104 that is coupled to a system bus 106. The processor unit 104 may utilize one or more processors, each of which has one or more processor cores. A graphics adapter 108, which drives/supports the display 120, is also coupled to system bus 106. The graphics adapter 108 may, for example, include a graphics processing unit (GPU). The system bus 106 is coupled via a bus bridge 112 to an input/output (I/O) bus 114. An I/O interface 116 is coupled to the I/O bus 114. The I/O interface 116 affords communication with various I/O devices, such as a keyboard 118 (perhaps as a touch screen virtual keyboard), and a USB mouse 124 via USB port(s) 126 (or other type of pointing device, such as a trackpad). The I/O bus 114 may also provide communication to the BMC 30. As depicted, the computer 100 may communicate with other devices over the network 18 using a network adapter or network interface controller (NIC) 130. The hardware elements depicted in the computer 100 are not intended to be exhaustive, but rather are representative. For instance, the computer 100 may include non-volatile memory and the like.

A hard drive interface 132 is also coupled to the system bus 106. The hard drive interface 132 interfaces with a hard drive 134. In a preferred embodiment, the hard drive 134 communicates with system memory 136, which is also coupled to the system bus 106. System memory is defined as the lowest level of volatile memory in the computer 100. This volatile memory may include additional higher levels of volatile memory (not shown), including, but not limited to, cache memory, registers and buffers. Data that populates the system memory 136 may include an operating system (OS) 138 and application programs 144.

The operating system 138 includes a shell 140 for providing transparent user access to resources such as application programs 144. Generally, the shell 140 is a program that provides an interpreter and an interface between the user and the operating system. More specifically, the shell 140 executes commands that are entered into a command line user interface or from a file. Thus, the shell 140, also called a command processor, is generally the highest level of the operating system software hierarchy and serves as a command interpreter. The shell may provide a system prompt, interpret commands entered by keyboard, mouse, or other user input media, and send the interpreted command(s) to the appropriate lower levels of the operating system (e.g., a kernel 142) for processing. Note that while the shell 140 may be a text-based, line-oriented user interface, embodiments may support other user interface modes, such as graphical, voice, gestural, etc. As depicted, the operating system 138 also includes the kernel 142, which may include lower levels of functionality for the operating system 138, including providing essential services required by other parts of the operating system 138 and application programs 144. Such essential services may include memory management, process and task management, disk management, and mouse and keyboard management. As shown, the computer 100 includes application programs 144 in the system memory of the computer 100. Where the computer 100 is representative of a server 40, the computer may further include a baseboard management controller (BMC) 131 to perform out-of-band processing and monitor and manage various features of the hardware components of the computer.

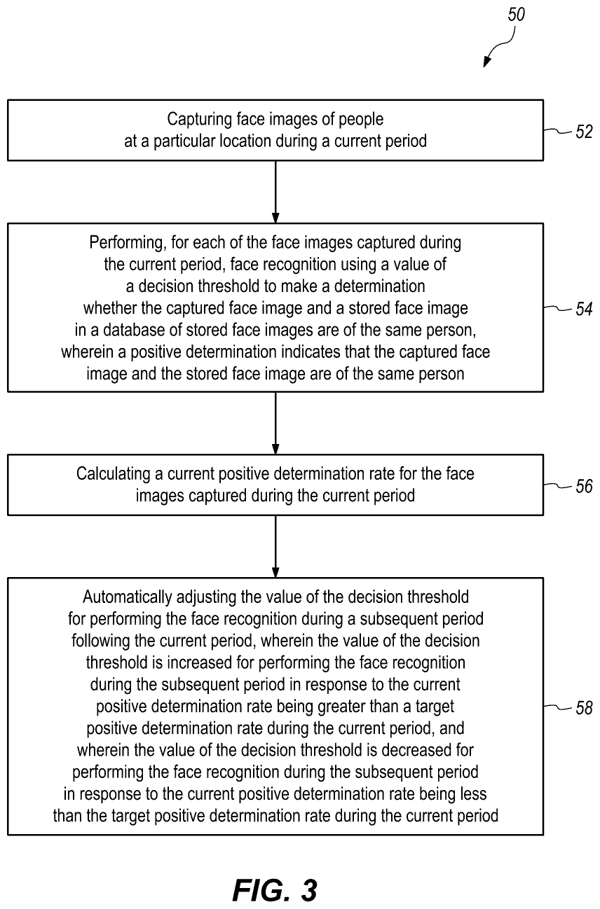

FIG. 3 is a flowchart of operations 50 according to some embodiments. Operation 52 includes capturing face images of people at a particular location during a current period. Operation 54 includes performing, for each of the face images captured during the current period, face recognition using a value of a decision threshold to make a determination whether the captured face image and a stored face image in a database of stored face images are of the same person, wherein a positive determination indicates that the captured face image and the stored face image are of the same person. Operation 56 includes calculating a current positive determination rate for the face images captured during the current period. Operation 58 includes automatically adjusting the value of the decision threshold for performing the face recognition during a subsequent period following the current period, wherein the value of the decision threshold is increased for performing the face recognition during the subsequent period in response to the current positive determination rate being greater than a target positive determination rate during the current period, and wherein the value of the decision threshold is decreased for performing the face recognition during the subsequent period in response to the current positive determination.

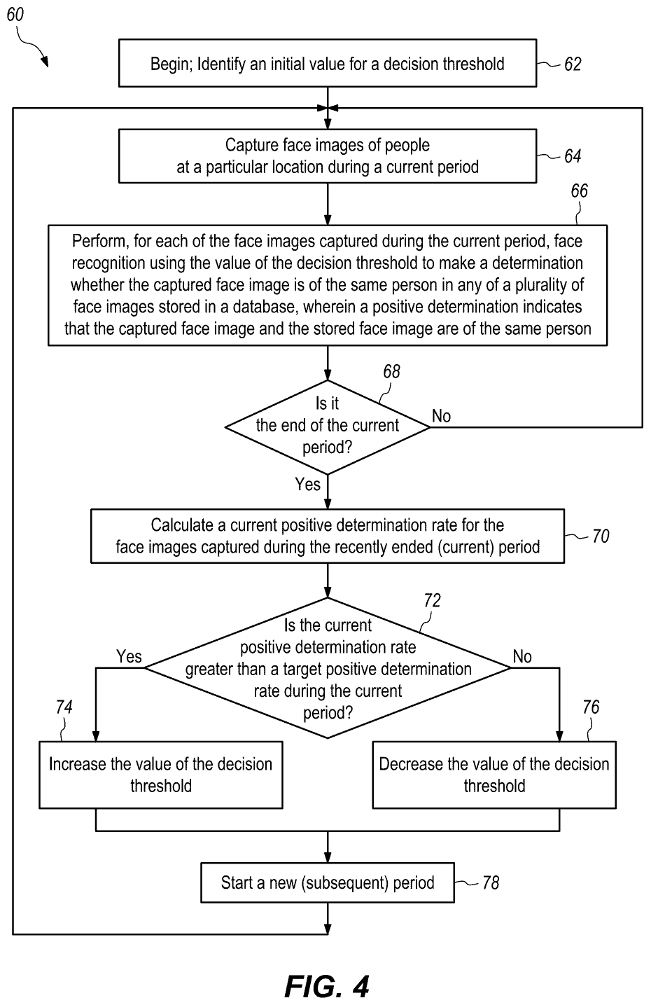

FIG. 4 is a flowchart of operations 60 according to some embodiments. In operation 62, the process begins, and the process identifies an initial value for a decision threshold. In operation 64, the process will capture face images of people at a particular location during a current period. In operation 66, the process performs, for each of the face images captured during the current period, face recognition using the value of the current (initial) decision threshold to make a determination whether the captured face image is of the same person in any of a plurality of face images stored in a database, wherein a positive determination indicates that the captured face image and the stored face image are of the same person. In operation 68, the process determines whether it is the end of the current period. If it is not the end of the current period, then the process returns to operation 64. If it is the end of the current period, then the process proceeds to operation 70.

In operation 70, the process calculates a current positive determination rate for the face images captured during the recently ended (current) period. In operation 72, the process determines whether the current positive determination rate is greater than a target positive determination rate during the current period. If the current positive determination rate is greater than a target positive determination rate during the current period, then the process proceeds to operation 74, where the process increases the value of the decision threshold. If the current positive determination rate is not greater than a target positive determination rate during the current period, then the process proceeds to operation 76, where the process decreases the value of the decision threshold. After either operation 74 or operation 76, the process proceeds with operation 78 to start a new (subsequent) period and return to operation 64 using the adjusted decision threshold.

As will be appreciated by one skilled in the art, embodiments may take the form of a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device. Furthermore, any program instruction or code that is embodied on such computer readable storage media (including forms referred to as volatile memory) that is not a transitory signal are, for the avoidance of doubt, considered “non-transitory”.

Program code embodied on a computer readable storage medium may be transmitted using any appropriate medium, including but not limited to wireless, wireline, optical fiber cable, RF, etc., or any suitable combination of the foregoing. Computer program code for carrying out various operations may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments may be described with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored on computer readable storage media is not a transitory signal, such that the program instructions can direct a computer, other programmable data processing apparatus, or other devices to function in a particular manner, and such that the program instructions stored in the computer readable storage medium produce an article of manufacture.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to limit the scope of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the embodiment.

The corresponding structures, materials, acts, and equivalents of all means or steps plus function elements in the claims below are intended to include any structure, material, or act for performing the function in combination with other claimed elements as specifically claimed. Embodiments have been presented for purposes of illustration and description, but it is not intended to be exhaustive or limited to the embodiments in the form disclosed. Many modifications and variations will be apparent to those of ordinary skill in the art after reading this disclosure. The disclosed embodiments were chosen and described as non-limiting examples to enable others of ordinary skill in the art to understand these embodiments and other embodiments involving modifications suited to a particular implementation.

What is claimed is:

1. A computer program product comprising a non-volatile computer readable medium and non-transitory program instructions embodied therein, the program instructions being configured to be executable by a processor to cause the processor to perform operations comprising:
capturing face images of people at a particular location during a current period;
performing, for each of the face images captured during the current period, face recognition using a value of a decision threshold to make a determination whether the captured face image and a stored face image in a database of stored face images are of the same person, wherein a positive determination indicates that the captured face image and the stored face image are of the same person;
calculating a current positive determination rate for the face images captured during the current period; and
automatically adjusting the value of the decision threshold for performing the face recognition during a subsequent period following the current period, wherein the value of the decision threshold is increased for performing the face recognition during the subsequent period in response to the current positive determination rate being greater than a target positive determination rate during the current period, and wherein the value of the decision threshold is decreased for performing the face recognition during the subsequent period in response to the current positive determination rate being less than the target positive determination rate during the current period.

2. The computer program product of claim 1, the operations further comprising:
repeating the operations during each of a plurality of sequential periods.

3. The computer program product of claim 1, wherein the positive determination indicates that the captured face image is of the same person as in any of the stored face images in the database.

4. The computer program product of claim 1, wherein increasing the value of the decision threshold requires greater similarity between the captured face image and the stored face image to determine a positive match.

5. The computer program product of claim 1, wherein decreasing the value of the decision threshold requires less similarity between the captured face image and the stored face image to determine a positive match.

6. The computer program product of claim 1, wherein the operation of performing, for each of the face images captured during the current period, face recognition includes:
calculating, for each of the face images captured during the current period, an amount of difference between a face print for the captured face image with a face print for each of a plurality of stored face images; and
making a positive determination for the captured face image in response to the calculated amount of difference being less than the value of the decision threshold.

7. The computer program product of claim 1, wherein the operation of automatically adjusting the value of the decision threshold for performing face recognition during the subsequent period following the current period includes:
incrementally adjusting the value of the decision threshold by a predetermined amount.

8. The computer program product of claim 1, wherein each of the periods is defined by an amount of time or a number of determinations whether the captured face image is of the same person as one of the stored face images in the database of stored face images.

9. The computer program product of claim 1, wherein the current period ends and the subsequent period begins in response to a difference between the current positive determination rate and the target positive determination rate exceeding a maximum threshold.

10. The computer program product of claim 1, wherein the operation of calculating the current positive determination rate for the face images captured during the current period includes:
identifying a total number of the determinations are made during the current period;
identifying a number of positive determinations made during the current period, wherein the current positive determination rate is the number of positive determinations divided by the total number of determinations.

11. The computer program product of claim 1, wherein the operation of capturing face images of people at the particular location during the current period includes:
receiving the face images from a camera mounted in the particular location.

12. The computer program product of claim 1, wherein the operation of performing, for each of the face images captured during the current period, face recognition using a value of a decision threshold to make a determination whether the captured face image and a stored face image in a database of stored face images are of the same person includes:
submitting the captured face image, one or more of the stored face images in the database, and the value of the decision threshold to a face recognition system; and
receiving the determination whether the captured face image and any of the one or more of the stored face images in a database are of the same person from the face recognition system.

13. The computer program product of claim 1, wherein the target positive determination rate is a known value based on previous experience.

14. The computer program product of claim 1, wherein the target positive determination rate is designated according to a capacity to process positive determinations.

15. The computer program product of claim 1, wherein the automatic adjusting of the value of the decision threshold adapts to changes in environmental conditions affecting quality of the face images captured at the particular location.

16. A method, comprising:
capturing face images of people at a particular location during a current period;
performing, for each of the face images captured during the current period, face recognition using a value of a decision threshold to make a determination whether the captured face image and a stored face image in a database of stored face images are of the same person, wherein a positive determination indicates that the captured face image and the stored face image are of the same person;
calculating a current positive determination rate for the face images captured during the current period; and
automatically adjusting the value of the decision threshold for performing the face recognition during a subsequent period following the current period, wherein the value of the decision threshold is increased for performing the face recognition during the subsequent period in response to the current positive determination rate being greater than a target positive determination rate during the current period, and wherein the value of the decision threshold is decreased for performing the face recognition during the subsequent period in response to the current positive determination rate being less than the target positive determination rate during the current period.

17. The method of claim 16, the operations further comprising:
repeating the operations during each of a plurality of sequential periods.

18. The method of claim 16, wherein the positive determination indicates that the captured face image is of the same person as in any of the stored face images in the database.

19. The method of claim 16, wherein increasing the value of the decision threshold requires greater similarity between face two images to determine a positive match.

20. The method of claim 16, wherein decreasing the value of the decision threshold requires less similarity between the captured face image and the stored face image to determine a positive match.
